(19) United States
(12) Patent Application Publication
(10) Pub. No.: US 2023/0168924 A1
(43) Pub. Date: Jun. 1, 2023

(54) APPARATUS FOR PRELOADING DATA IN DISTRIBUTED COMPUTING ENVIRONMENT AND METHOD USING THE SAME

(71) Applicant: ELECTRONICS AND TELECOMMUNICATIONS RESEARCH INSTITUTE, Daejeon (KR)

(72) Inventors: Myung-Hoon CHA, Daejeon (KR); Hong-Yeon KIM, Daejeon (KR); Baik-Song AN, Daejeon (KR); Sang-Min LEE, Daejeon (KR)

(21) Appl. No.: 17/898,686

(22) Filed: Aug. 30, 2022

(30) Foreign Application Priority Data
Nov. 30, 2021 (KR) 10-2021-0168455

(51) Int. Cl. G06F 9/48; G06F 9/38; G06F 9/52

(52) U.S. Cl. CPC G06F 9/4881; G06F 9/3871; G06F 9/52

(57) ABSTRACT

Disclosed herein are an apparatus for preloading data in a distributed computing environment and a method using the same. The method includes selecting a local preloading target that each of multiple computers connected over a network is to preload into the local memory thereof, registering a local preloading task corresponding to the local preloading target in local preloading metadata, and asynchronously starting the local preloading task at a preset time based on the local preloading metadata. The local preloading metadata is stored in a page other than the page in which remote preloading metadata for managing a remote preloading task is stored.

### CROSS REFERENCE TO RELATED APPLICATION

This application claims the benefit of Korean Patent Application No. 10-2021-0168455, filed Nov. 30, 2021, which is hereby incorporated by reference in its entirety into this application.

### BACKGROUND OF THE INVENTION

### 1. Technical Field

The present invention relates generally to technology for preloading data in a distributed computing environment, and more particularly to technology for improving the efficiency of a data-preloading system by effectively accelerating the process of preloading data and processing the same.

### 2. Description of the Related Art

In software that uses a group of multiple computers connected over a network as virtualized abstract resources, such as Distributed Shared Memory (DSM), a distributed operating system, a distributed hypervisor, and the like, when required data is loaded into memory in units of a fixed size, performance may vary depending on the location of the computer containing the data to be loaded. For example, although a memory page may be shown on distributed shared memory, the original copy thereof may be physically stored in a remote computer. Accordingly, when the data to be loaded into memory is located in a local computer, the data is processed much faster than when the data is located in a remote computer.

Also, a situation similar to the above-described situation occurring in a cluster of distributed computers may occur even in a single computer when multiple CPU sockets are present, as in a Non-Uniform Memory Access (NUMA) machine, or when memory access speed is not uniform due to the separation between local memory units of the respective sockets. That is, data loaded into the memory adjacent to the CPU currently being used in the NUMA machine is processed very quickly, but access to memory connected to a remote socket with which the currently used CPU is not associated is processed slowly.

When it is intended to load, in advance, data to be processed later, if an existing method in which whether the source of the data to be loaded is local or remote is not known is used, the cost of moving data between computers or between NUMA nodes increases excessively, so it is difficult to sufficiently to realize the advantages of preloading.

Therefore, in an environment in which virtualization is implemented on physical resources accessed at different speeds, such as a cluster of computers or a NUMA machine, a preloading method capable of recognizing local and remote resources and effectively using the relationship therebetween is required.

### DOCUMENTS OF RELATED ART

(Patent Document 1) Korean Patent Application Publication No. 10-2016-0135250, published on Nov. 25, 2016 and titled “Prefetching application data for periods of disconnectivity”.

### SUMMARY OF THE INVENTION

An object of the present invention is to store and manage metadata for local preloading and metadata for remote preloading in different pages, thereby preventing frequent movement of metadata, which is caused by generating, updating, or deleting metadata representations for scheduled preloading tasks, in a virtualization environment configured with multiple computers.

Another object of the present invention is to prevent preloading of data from causing redundant loading of pages, thereby more efficiently processing preloading.

A further object of the present invention is to prevent inefficiency caused by data-prefetching overhead in a virtualization environment configured with multiple computers, thereby improving the usefulness of data preloading.

In order to accomplish the above objects, a method for preloading data according to the present invention includes selecting a local preloading target that each of multiple computers connected over a network is to preload into the local memory thereof, registering a local preloading task corresponding to the local preloading target in local preloading metadata, and asynchronously starting the local preloading task at a preset time based on the local preloading metadata. The local preloading metadata is stored in a page other than a page in which remote preloading metadata for managing a remote preloading task is stored.

Here, the method may further include checking whether the local preloading target is redundant based on a synchronously loaded page stored in the local preloading metadata before performing the asynchronously started local preloading task.

Here, the synchronously loaded page may include data synchronously loaded into the local memory so as to be immediately referenced from the current execution context of a CPU.

Here, the method may further include stopping the local preloading task when the local preloading target is redundant with the synchronously loaded data.

Here, the local preloading task may be a preloading task, the range of which is a local computer, and the remote preloading task may be a preloading task, the range of which is a remote computer.

Here, the multiple computers may individually generate and manage the local preloading metadata and the remote preloading metadata.

Here, the local preloading target may be selected so as to correspond to a page physically adjacent to the currently referenced page in consideration of the current execution context of a CPU.

Here, information about the synchronously loaded page may be stored for a preset period.

Also, an apparatus for preloading data according to an embodiment of the present invention includes a processor for selecting a local preloading target that each of multiple computers connected over a network is to preload into the local memory thereof, registering a local preloading task corresponding to the local preloading target in local preloading metadata, and asynchronously starting the local preloading task at a preset time based on the local preloading metadata, and memory for storing the local preloading metadata. The local preloading metadata is stored in a page other than a page in which remote preloading metadata for managing a remote preloading task is stored.

Here, the processor may check whether the local preloading target is redundant based on a synchronously loaded page stored in the local preloading metadata before performing the asynchronously started local preloading task.

Here, the synchronously loaded page may include data synchronously loaded into the local memory so as to be immediately referenced from the current execution context of a CPU.

Here, the processor may stop the local preloading task when the local preloading target is redundant with the synchronously loaded data.

Here, the local preloading task may be a preloading task, the range of which is a local computer, and the remote preloading task may be a preloading task, the range of which is a remote computer.

Here, the multiple computers may individually generate and manage the local preloading metadata and the remote preloading metadata.

Here, the local preloading target may be selected so as to correspond to a page physically adjacent to the currently referenced page in consideration of the current execution context of a CPU.

Here, information about the synchronously loaded page may be stored for a preset period.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating a system for preloading data in a distributed computing environment according to an embodiment of the present invention;

FIG. 2 is a flowchart illustrating a method for preloading data in a distributed computing environment according to an embodiment of the present invention;

FIG. 3 is a view illustrating an example of a process of preloading data in a distributed computing environment according to the present invention;

FIG. 4 is a flowchart illustrating in detail a process of checking whether a local preloading target is redundant in a method for preloading data in a distributed computing environment according to an embodiment of the present invention;

FIG. 5 is a view illustrating an apparatus for preloading data in a distributed computing environment according to an embodiment of the present invention; and

FIG. 6 is a block diagram illustrating an apparatus for preloading data in a distributed computing environment according to another embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

In a system that preloads data to be processed at a later time, the technical focus is on locating data that is highly likely to be used and preloading the same and on selecting data that is less likely to be used, among data loaded into memory, and removing the same from the memory in consideration of the efficiency of use of memory having a limited size.

However, under the current circumstances, in which the size of data is rapidly increasing and the size of memory into which data can be loaded is also increasing, huge overhead is caused by moving data between computers, which significantly decreases the usefulness of data preloading in a virtualization environment configured with computers connected over a network.

For example, cases in which adverse effects are caused by preloading data in a virtualization environment configured with multiple computers are as follows.

First, an adverse effect is caused by frequently moving metadata for management of preloading. When a preloading system is operated in a virtualization environment based on a cluster of multiple computers, metadata for representing a preloading task has to be generated before the preloading task is performed. Also, when the preloading task is completed, the metadata must be updated in order to reflect the result.

Accordingly, the metadata area of the computer that most recently performed a preloading task has the most up-to-date valid content, whereas the metadata area of the computer that performed a preloading task before then has invalid content. Here, computers performing preloading tasks have to pay the expense of fetching the newest metadata. In connection therewith, as the number of computers participating in a cluster and the number of preloading tasks increase, metadata is more frequently moved between computers, whereby the entire overhead increases in proportion thereto. This is similar to movement of metadata between CPU sockets in a single Non-Uniform Memory Access (NUMA) machine.

Secondly, because data preloading is processed with low priority, redundant loading overhead may be incurred. An operation of immediately loading the currently required data and an operation of preloading data that may be required in the future are asynchronously performed because the two operations have different degrees of urgency in data processing.

For example, the task of loading the currently required data is immediately performed in a synchronous manner, but the task of preloading data that can be used in the future is processed with low priority because it is not urgent. Accordingly, in the state in which data has not been preloaded although the data was requested to be preloaded long before because the data was expected to be used, when the time at which the data is actually required arrives, synchronous loading of the data may be performed. In this case, a task of preloading the data may be redundantly performed in the background.

In order to solve the above-mentioned problems, the present invention intends to propose technology that supports data preloading and improves the efficiency of a data-preloading system so as to prevent overhead caused by moving metadata or redundant loading.

Here, the present invention is intended for a system that loads data into memory in units of a fixed size and processes the same in an environment in which the resources of computers connected over a network are virtualized and used on clusters of the computers. Specifically, the present invention is applicable in the situation in which not only data that has to be currently processed but also data expected to be processed soon are loaded in order to improve efficiency of data processing.

Hereinafter, a preferred embodiment of the present invention will be described in detail with reference to the accompanying drawings.

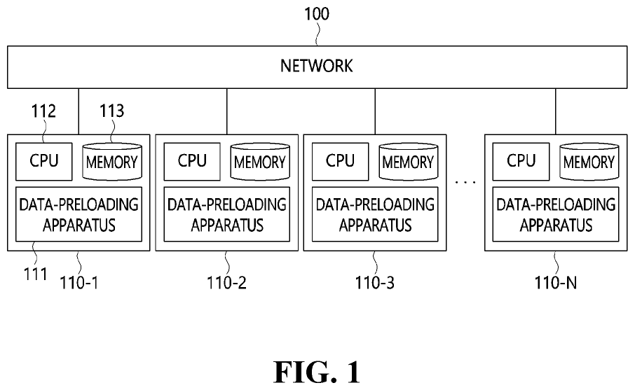

FIG. 1 is a view illustrating a system for preloading data in a distributed computing environment according to an embodiment of the present invention.

Referring to FIG. 1, the system for preloading data in a distributed computing environment according to an embodiment of the present invention includes multiple computers 110-1 to 110-N connected over a network 100 and data-preloading apparatuses 111 included in the respective computers.

Here, the data-preloading apparatus 111 according to the present invention may serve to efficiently process data preloading by preventing frequent movement of metadata, which is caused by generating, updating, or deleting metadata representations of a data-preloading task in each computer, and preventing data preloading from causing loading of redundant pages.

Existing methods for managing metadata describing a data-preloading task are broadly classified into three methods.

In a first method, a single specific computer selected from among multiple computers participating in a virtualization environment is used for storing and managing metadata.

When metadata is managed using the first method, each of multiple computers connected over a network has to access a specific computer that manages metadata and fetch a preloading task list before performing a preloading task. Also, after the preloading task is completed, the computer has to again access the specific computer, which stores metadata therein, and delete metadata pertaining to the completed preloading task in order to reflect the result of the preloading task. That is, there is a problem in that remote communication between computers for accessing the specific computer that stores and manages metadata incurs a high cost.

In a second method, all computers participating in a virtualization environment may retain the same copy of metadata.

This method may be similarly applied in a situation in which distributed shared memory (DSM) is arranged and metadata is retained on the DSM.

When metadata is managed using the second method, because the metadata areas of all computers participating in a virtualization environment have to be synchronized whenever a data-preloading task is registered in metadata or whenever a data-preloading task registered in metadata is performed, there is a problem in that metadata synchronization incurs a high cost.

Meanwhile, as a variation of the second method, distributed shared memory (DSM) is configured for all computers in a virtualization environment, and metadata may be retained on the DSM.

In this case, when an IVY protocol, which is commonly used as a protocol for distributed shared memory (DSM), is employed, the following scenario may typically occur.

For example, when the newest metadata is retained in computer A and when metadata is added or updated in computer B, the metadata in computer A (strictly, a memory page containing the metadata) is fetched into computer B, and the original page in computer A may be invalidated. That is, in order to update a memory page, it is always necessary to fetch the original page from a remote computer and invalidate the same in the remote computer, which incurs considerable cost.

It may be assumed that metadata I and metadata J about preloading tasks are stored in a single memory page and that the memory page containing the newest metadata is stored in computer B. Here, when computer A intends to update I, the memory page in computer B, in which both I and J are stored, is first fetched into computer A, and the original page in computer B may be invalidated. Then, when computer B intends to update J, the newest memory page in computer A, in which both I and J are stored, is fetched into computer B, and the original page in computer A may be invalidated.

When preloading tasks are represented in the same memory page as described above, although multiple computers are interested in different preloading tasks, fetching and invalidation processes may continuously be passed back and forth between the computers. Also, because such an update process frequently occurs, when a preloading task list is managed in distributed shared memory (DSM), a high cost may be incurred while the preloading task is being processed.

In a third method, each of computers participating in a virtualization environment stores only a subset of all metadata, and the entire set of metadata may be formed by combining all of the metadata subsets stored in the respective computers.

When metadata is managed using the third method, because the computer to perform a data-preloading task may not be the same computer as the computer in which the target data to be preloaded is stored, the data-preloading task itself is required to be transferred over a network, which incurs a high cost.

The present invention is proposed in order to remedy disadvantages in the above-described existing metadata management methods.

The data-preloading apparatus 111 according to an embodiment of the present invention selects a local preloading target that each of the multiple computers connected over a network is to preload into the local memory thereof.

Here, the local preloading target may be selected so as to correspond to a page physically adjacent to the currently referenced page in consideration of the current execution context of a CPU.

Also, the data-preloading apparatus 111 registers a local preloading task corresponding to the local preloading target in local preloading metadata.

Here, the local preloading metadata may be stored in a page other than the page in which remote preloading metadata for managing a remote preloading task is stored.

Here, the local preloading task may be a preloading task, the range of which is a local computer, and the remote preloading task may be a preloading task, the range of which is a remote computer.

Here, each of the multiple computers may individually generate and manage local preloading metadata and remote preloading metadata.

Also, the data-preloading apparatus 111 asynchronously starts the local preloading task at a preset time based on the local preloading metadata.

Also, the data-preloading apparatus 111 checks whether the local preloading target is redundant based on a synchronously loaded page stored in the local preloading metadata before it performs the asynchronously started local preloading task.

Here, the synchronously loaded page may include data that is synchronously loaded into local memory so as to be immediately referenced from the current execution context of the CPU.

Here, information about the synchronously loaded page may be stored for a preset period.

Also, when the local preloading target is redundant with the synchronously loaded data, the data-preloading apparatus 111 stops the local preloading task.

Using the above-described data-preloading apparatus 111, frequent movement of metadata, which is caused by generating, updating, or deleting metadata representations for a data-preloading task, is prevented in a virtualization environment configured with multiple computers, and redundant pages are prevented from being loaded, whereby data preloading may be efficiently processed.

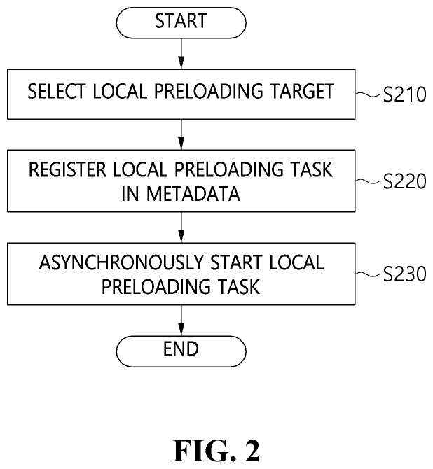

FIG. 2 is a flowchart illustrating a method for preloading data in a distributed computing environment according to an embodiment of the present invention.

Referring to FIG. 2, in the method for preloading data in a distributed computing environment according to an embodiment of the present invention, each of multiple computers connected over a network selects a local preloading target to preload into the local memory thereof at step S210.

Here, the local preloading target may be selected so as to correspond to a page physically adjacent to the currently referenced page in consideration of the current execution context of a CPU.

For example, a page physically adjacent to the page currently referenced by a CPU may be selected as the target to be preloaded. However, the present invention is focused on selecting the target to be preloaded in the same computer, having the CPU corresponding to the current execution context, and as long as this condition is satisfied, the method of selecting the target in the corresponding computer is not limited to any specific method.

Here, in each of the computers, the target to be preloaded is selected from among data locally stored in the computer in consideration of the current execution context of a CPU, whereby a problem with conventional technology in which a high cost is incurred because the computer that is to perform a data-preloading task is not the same computer as that in which the data to be preloaded is stored may be solved.

Also, in the method for preloading data in a distributed computing environment according to an embodiment of the present invention, a local preloading task corresponding to the local preloading target is registered in local preloading metadata at step S220.

Here, the local preloading metadata may be stored in a page other than the page in which remote preloading metadata for managing a remote preloading task is stored.

Here, the local preloading task may be a preloading task, the range of which is a local computer, and the remote preloading task may be a preloading task, the range of which is a remote computer.

Here, each of the multiple computers may individually generate and manage local preloading metadata and remote preloading metadata.

That is, local preloading metadata, which describes a scheduled local preloading task, is collected and recorded in the local memory of the computer in which the task is to be performed, in which case the local preloading metadata may be separated from remote preloading metadata for the preloading tasks of a remote computer such that the two types of metadata are prevented from being mixed in the same memory page. Accordingly, computers in a cluster individually maintain metadata describing the local preloading task to perform therein by collecting the same in a specific memory page, and this page does not contain the preloading tasks to be performed in a remote computer.

As described above, because a local preloading task list is strictly separated from a remote preloading task list in the present invention, when the local preloading task list is retrieved, there is no need to fetch the same from a remote computer. Also, because the result of a preloading task is reflected only in the local page, the cost of synchronizing the result with all computers in a cluster is avoided.

Particularly, when distributed shared memory (DSM) is used, metadata pertaining to preloading tasks to be performed in other computers may be recorded in the memory of a local computer according to a DSM protocol, but a page in which a list of local preloading tasks to be performed in the local computer is recorded may be managed in the state of being strictly separated from the page in which a list of remote preloading tasks, which are to be performed in a remote computer, is recorded.

Accordingly, even though DSM is used, update of one item included in a certain page does not cause update of the same page or a similar page in other computers, whereby repeated communication between computers caused by updating a memory page does not occur.

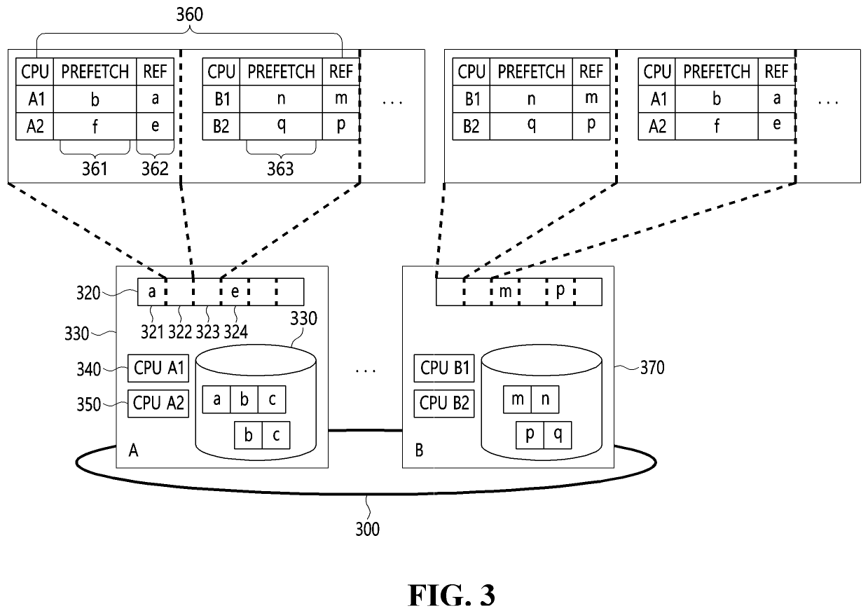

Hereinafter, the process of performing a local preloading task according to the present invention will be described in detail with reference to FIG. 3.

FIG. 3 illustrates an environment in which multiple computers 310 and 370 are connected over a network 300, whereby various forms such as distributed shared memory, a distributed file system, a distributed operating system, a distributed hypervisor, and the like may be realized.

Referring to FIG. 3, computer A 310 has a disk 330 and local memory 320, and has CPUs 340 and 350. Here, it may be assumed that CPU A1 340 refers to page ‘a’ 321 in the local memory 320 and CPU A2 350 refers to page ‘e’ 324 in the local memory 320 in computer A 310.

Here, metadata pertaining to preloading tasks is managed separately based on whether the execution range of each task is local or remote, and the memory page 322 in which local preloading tasks are recorded may be separated from the memory page 323 in which preloading tasks remote from computer A 310 are recorded.

The lists of the preloading tasks contained in these memory pages 322 and 323 may be collectively referred to as preloading metadata 360 for preloading tasks.

Here, local preloading tasks 361 based on computer A 310, recorded in the preloading metadata 360, may correspond to tasks associated with data ‘b’ and data ‘f’. Accordingly, the local preloading metadata indicating that data ‘b’ and data ‘f’ are scheduled to be loaded into the local memory 320 is contained in the memory page 322 for the local preloading tasks.

Also, remote preloading tasks 363 to be processed in a computer 370 remote from computer A 310 may be represented in the memory page 323 in computer A 310, and the memory page 323 may be separated from the memory page 322 in which local tasks are arranged.

Accordingly, even when a preloading task in computer A 310 is performed in an environment in which a drastic operation protocol using distributed shared memory is employed, an adverse effect in which metadata 360 is repeatedly passed back and forth between the computers 310 and 370 may be prevented. Also, because local preloading tasks are locally performed in computer A 310, the efficiency of data loading may be improved from the aspect of data processing.

Here, computing resources forming the system for preloading data according to an embodiment of the present invention may include virtualized resources directly used for data preloading and some physical resources that are obtained from multiple computers and abstracted to virtualized resources.

Accordingly, based on a hierarchical resource configuration including virtualized resources and physical resources, when a physical resource abstracted to a virtualized resource is disposed in the same computer as the virtualized resource, preloading may be performed with higher performance than when it is disposed in a computer other than the computer in which the virtualized resource is disposed.

Also, in the method for preloading data in a distributed computing environment according to an embodiment of the present invention, a local preloading task is asynchronously started at a preset time based on the local preloading metadata at step S230.

Also, although not illustrated in FIG. 2, in the method for preloading data in a distributed computing environment according to an embodiment of the present invention, whether the local preloading target is redundant is checked based on a synchronously loaded page, which is stored in the local preloading metadata, before the asynchronously started local preloading task is performed.

Here, the synchronously loaded page may include data that is synchronously loaded into local memory so as to be immediately referenced from the current execution context of the CPU.

Here, information about the synchronously loaded page may be stored for a preset period. Accordingly, when the preset period expires, the information about the synchronously loaded page may be automatically deleted.

For example, in the case of data required by a CPU at that time, a process of loading the data into a memory area has to be synchronously performed. However, a task of preloading data to be used later may be asynchronously processed because it has low priority.

This discrepancy may cause redundant data loading.

For example, it may be assumed that a request for preloading certain data was registered a long time previously, but preloading has not been completed. Here, when the time at which a CPU requires the data arrives, a system starts synchronous loading of the data, and at the same time, an operation of preloading the data may be redundantly performed in the background.

The present invention has the technical object of preventing such redundant loading by recognizing this situation.

Also, although not illustrated in FIG. 2, in the method for preloading data in a distributed computing environment according to an embodiment of the present invention, when the local preloading target is redundant with the synchronously loaded data, the local preloading task is stopped.

For example, referring to FIG. 3, information about the original copies of the pages 321 and 324 currently referenced by the CPUs 340 and 350 of computer A 310 (that is, data ‘a’ and data ‘e’ stored on the disk 330) is also managed so as to match information about the synchronously loaded page 362 in part of the metadata 360, so the information may be used as a means for preventing the pages to be preloaded from being redundantly loaded.

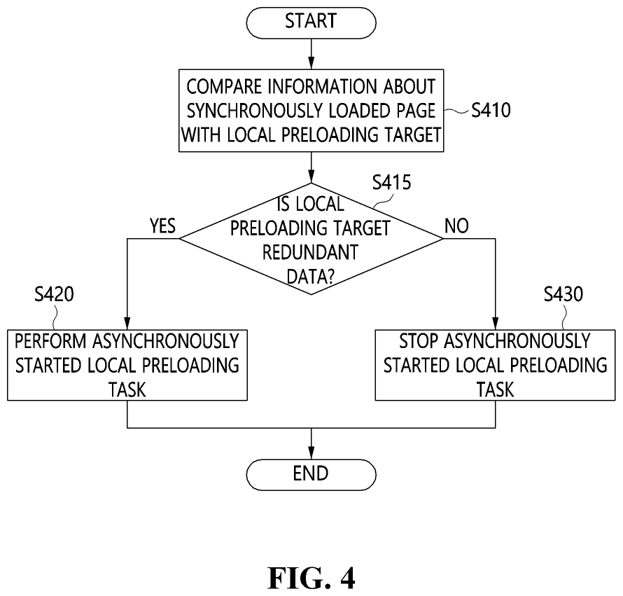

Hereinafter, a process for preventing redundant loading will be described in detail with reference to FIG. 4.

Referring to FIG. 4, first, information about a synchronously loaded page, which is included in part of local preloading metadata, is compared with a local preloading target at step S410.

For example, immediately before asynchronously starting a local preloading task, each of computers may compare the local preloading task with the result of synchronous loading tracked by the computer.

Whether the local preloading target is data redundant with the already loaded data included in the synchronously loaded page is determined at step S415 through the comparison.

For example, whether the local preloading task is a task for preloading the same data as the recently loaded data may be determined.

When it is determined at step S415 that the local preloading target is not redundant data, the asynchronously started local preloading task is performed at step S420.

Also, when it is determined at step S415 that the local preloading target is redundant data, the asynchronously started local preloading task is stopped, whereby data is prevented from being redundantly loaded at step S430.

Here, information about the stopped task may be removed from the local preloading metadata.

Through the above-described method for preloading data, each computer participating in a virtualization environment configured with multiple computers may separately manage local preloading metadata and remote preloading metadata in units of memory pages, and redundant data loading may be prevented.

That is, metadata for local preloading and metadata for remote preloading are managed by being stored in different pages, whereby frequent movement of metadata caused by generating, updating, or deleting metadata representations for scheduled preloading tasks may be prevented in a virtualization environment configured with multiple computers.

Also, preloading of data is prevented from causing loading of redundant pages, whereby preloading may be efficiently processed.

Also, inefficiency caused by data-prefetching overhead is prevented in a virtualization environment configured with multiple computers, whereby the usefulness of data preloading may be improved.

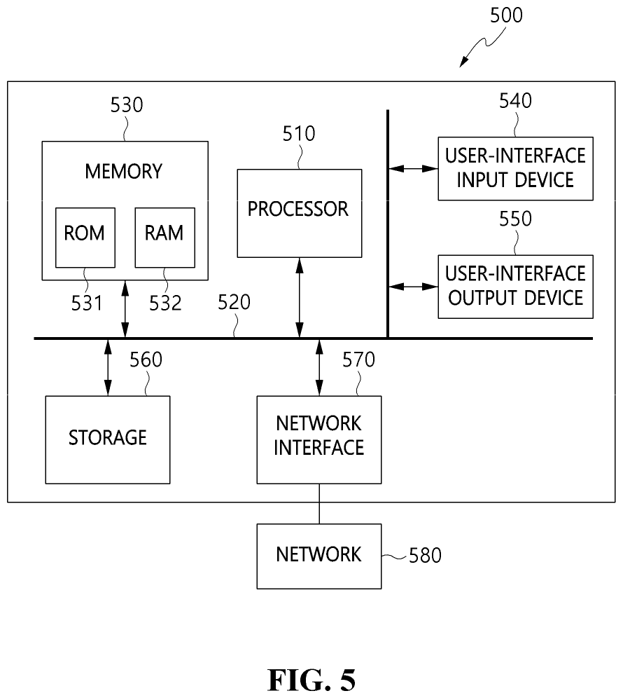

FIG. 5 is a view illustrating an apparatus for preloading data in a distributed computing environment according to an embodiment of the present invention.

Referring to FIG. 5, the apparatus for preloading data in a distributed computing environment according to an embodiment of the present invention may be implemented in a computer system including a computer-readable recording medium. As illustrated in FIG. 5, the computer system 500 may include one or more processors 510, memory 530, a user-interface input device 540, a user-interface output device 550, and storage 560, which communicate with each other via a bus 520. Also, the computer system 500 may further include a network interface 570 connected to a network 580. The processor 510 may be a central processing unit or a semiconductor device for executing processing instructions stored in the memory 530 or the storage 560. The memory 530 and the storage 560 may be any of various types of volatile or nonvolatile storage media. For example, the memory may include ROM 531 or RAM 532.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

The processor 510 selects a local preloading target that each of multiple computers connected over a network is to preload into the local memory thereof

Here, the local preloading target may be selected so as to correspond to a page physically adjacent to the currently referenced page in consideration of the current execution context of a CPU.

Also, the processor 510 registers a local preloading task corresponding to the local preloading target in local preloading metadata.

Here, the local preloading metadata may be stored in a page other than the page in which remote preloading metadata for managing a remote preloading task is stored.

Here, the local preloading task may be a preloading task, the range of which is a local computer, and the remote preloading task may be a preloading task, the range of which is a remote computer.

Here, each of the multiple computers may individually generate and manage local preloading metadata and remote preloading metadata.

Also, the processor 510 asynchronously starts the local preloading task at a preset time based on the local preloading metadata.

Also, the processor 510 checks whether the local preloading target is redundant based on a synchronously loaded page stored in the local preloading metadata before it performs the asynchronously started local preloading task.

Here, the synchronously loaded page may include data that is synchronously loaded into local memory so as to be immediately referenced from the current execution context of the CPU.

Here, information about the synchronously loaded page may be stored for a preset period.

Also, the processor 510 stops the local preloading task when the local preloading target is redundant with the synchronously loaded data.

The memory 530 stores the local preloading metadata and the remote preloading metadata.

Through the above-described apparatus for preloading data, metadata for local preloading and metadata for remote preloading are managed by being stored in different pages, whereby frequent movement of metadata caused by generating, updating, or deleting metadata representations for scheduled preloading tasks may be prevented in a virtualization environment configured with multiple computers.

Also, preloading of data is prevented from causing loading of redundant pages, whereby preloading may be efficiently processed.

Also, inefficiency caused by data-prefetching overhead is prevented in a virtualization environment configured with multiple computers, whereby the usefulness of data preloading may be improved.

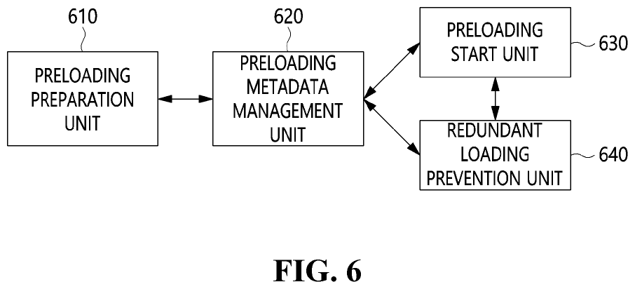

FIG. 6 is a block diagram illustrating an apparatus for preloading data in a distributed computing environment according to another embodiment of the present invention.

Referring to FIG. 6, the apparatus for preloading data in a distributed computing environment according to another embodiment of the present invention may include a preloading preparation unit 610, a preloading metadata management unit 620, a preloading start unit 630, and a redundant loading prevention unit 640.

The preloading preparation unit 610 may select the target page to be preloaded in consideration of the current execution context of a CPU.

For example, a page physically adjacent to the page currently referenced by a CPU may be selected as the target to be preloaded. However, the present invention is focused on selecting the target to be preloaded in the same computer having the CPU corresponding to the current execution context, and as long as this condition is satisfied, the method of selecting the target in the corresponding computer is not limited to any specific method.

The preloading metadata management unit 620 may efficiently manage the preloading task selected by the preloading preparation unit 610 in consideration of the location thereof.

Here, based on a CPU in a specific computer in a virtualization environment configured with multiple computers, only data residing in the computer having the CPU may be selected as the target to be preloaded in the corresponding computer. The preloading task for the preloading target selected as described above may be a local task restricted to the corresponding computer.

Accordingly, the preloading metadata management unit 620 may arrange the local preloading tasks in a specific page in the corresponding computer in which local preloading tasks are collectively contained.

Also, the preloading metadata management unit 620 may also manage a memory page representing preloading tasks to be performed in a remote computer. However, the memory page in which the remote preloading tasks are arranged may be a page other than the memory page in which the local preloading tasks are arranged.

The preloading start unit 630 asynchronously starts the preloading task, registered by the preloading metadata management unit 620, at an appropriate time. This task is one of the local preloading tasks managed by each computer, so network traffic between the computers in the virtualization environment is not generated.

The redundant loading prevention unit 640 retains information about synchronously loaded pages, which are loaded because the pages are immediately required by a CPU, for a limited period, and may use the same in order to check redundancy before the preloading start unit 630 starts the preloading task. Through this process, redundant preloading tasks are excluded, whereby redundant loading tasks may be avoided.

According to the present invention, metadata for local preloading and metadata for remote preloading are managed by being stored in different pages, whereby frequent movement of metadata caused by generating, updating, or deleting metadata representations for scheduled preloading tasks may be prevented in a virtualization environment configured with multiple computers.

Also, the present invention prevents preloading of data from causing loading of redundant pages, thereby efficiently processing preloading.

Also, the present invention prevents inefficiency caused by data-prefetching overhead in a virtualization environment configured with multiple computers, thereby improving the usefulness of data preloading.

As described above, the apparatus for preloading data in a distributed computing environment and the method using the same according to the present invention are not limitedly applied to the configurations and operations of the above-described embodiments, but all or some of the embodiments may be selectively combined and configured, so the embodiments may be modified in various ways.

What is claimed is:

1. A method for preloading data, comprising:
selecting a local preloading target that each of multiple computers connected over a network is to preload into local memory thereof;
registering a local preloading task corresponding to the local preloading target in local preloading metadata; and
asynchronously starting the local preloading task at a preset time based on the local preloading metadata,
wherein the local preloading metadata is stored in a page other than a page in which remote preloading metadata for managing a remote preloading task is stored.

2. The method of claim 1, further comprising:
checking whether the local preloading target is redundant based on a synchronously loaded page stored in the local preloading metadata before performing the asynchronously started local preloading task.

3. The method of claim 2, wherein the synchronously loaded page includes data synchronously loaded into the local memory so as to be immediately referenced from a current execution context of a CPU.

4. The method of claim 3, further comprising:
stopping the local preloading task when the local preloading target is redundant with the synchronously loaded data.

5. The method of claim 1, wherein the local preloading task is a preloading task, a range of which is a local computer, and the remote preloading task is a preloading task, a range of which is a remote computer.

6. The method of claim 1, wherein the multiple computers individually generate and manage the local preloading metadata and the remote preloading metadata.

7. The method of claim 1, wherein the local preloading target is selected so as to correspond to a page physically adjacent to a currently referenced page in consideration of a current execution context of a CPU.

8. The method of claim 2, wherein information about the synchronously loaded page is stored for a preset period.

9. An apparatus for preloading data, comprising:
a processor for selecting a local preloading target that each of multiple computers connected over a network is to preload into local memory thereof, registering a local preloading task corresponding to the local preloading target in local preloading metadata, and asynchronously starting the local preloading task at a preset time based on the local preloading metadata; and
memory for storing the local preloading metadata,
wherein the local preloading metadata is stored in a page other than a page in which remote preloading metadata for managing a remote preloading task is stored.

10. The apparatus of claim 9, wherein the processor checks whether the local preloading target is redundant based on a synchronously loaded page stored in the local preloading metadata before performing the asynchronously started local preloading task.

11. The apparatus of claim 10, wherein the synchronously loaded page includes data synchronously loaded into the local memory so as to be immediately referenced from a current execution context of a CPU.

12. The apparatus of claim 11, wherein the processor stops the local preloading task when the local preloading target is redundant with the synchronously loaded data.

13. The apparatus of claim 9, wherein the local preloading task is a preloading task, a range of which is a local computer, and the remote preloading task is a preloading task, a range of which is a remote computer.

14. The apparatus of claim 9, wherein the multiple computers individually generate and manage the local preloading metadata and the remote preloading metadata.

15. The apparatus of claim 9, wherein the local preloading target is selected so as to correspond to a page physically adjacent to a currently referenced page in consideration of a current execution context of a CPU.

16. The apparatus of claim 10, wherein information about the synchronously loaded page is stored for a preset period.
